(19) United States
(12) Patent Application Publication
(10) Pub. No.: US 2002/0007919 A1
(43) Pub. Date: Jan. 24, 2002

(54) Labeling machine for containers with non-cylindrical section

(75) Inventors: Giovanni Battista Cavaggioni, Castelbelforte (IT); Roberto Ruggeri, Mantova (IT)

Correspondence Address: LAFF, WHITESEL & SARET, LTD., 401 North Michigan Avenue, Chicago, IL, 60611, US

(73) Assignee: SASIB Labeling Machinery S.p.A.

(21) Appl. No.: 09/733,550

(22) Filed: Dec. 8, 2000

(30) Foreign Application Priority Data
Jul. 21, 2000 (IT) PR2000A000042

(51) Int. Cl. B32B 31/00

(52) U.S. Cl. 156/556

(57) ABSTRACT

The invention relates to labeling machines in which the labels are obtained from a reeled film and transferred by means of an aspirating roller, first against a roller that applies a vertical strip or points of heated glue, then on the container which is transported over a pan rotating about its own vertical axis and supported by a carrousel, itself rotating about an axis parallel to the axis of the pan. The aspirating roller for transferring the label comprises contact points positioned along a circumference centered on the axis of rotation of the roller between said points the roller is considerably recessed relative to the aforesaid circumference.

### BACKGROUND OF THE INVENTION

The present invention relates to a labeling machine of the type in which the labels are obtained from a reeled film.

Machines of this type comprise a device for unwinding the reel so that the film is routed to a cutting device which forms the label to be glued onto the container; the label thus formed is always rectangular or square and it always has two parallel vertical edges. From the cutting device the label is drawn by a roller which transfers it first in correspondence with a device that applies a stripe or points of glue and, subsequently, to the container to be labeled.

More specifically a strip of glue is applied along one of the vertical edges of the label, on the rear face, and subsequently a strip of glue on the other vertical edge which will be superposed and glued on the first edge.

The transfer roller, according to two known techniques, can be provided either with a set of pincers that hold the label in a perfectly tensioned position adhering to the lateral surface of the roller, or the cylinder can be constructed with internal cavities communicating by means of holes with said outer surface of the cylinder.

In said cavities a vacuum of adjustable intensity is created so that the labels continue to adhere to the surface of the roller during their transfer from the cutting device to the container.

The containers to be labeled are brought in contact with the roller for transferring the label by means of a linear transport or a circular transport commonly called carrousel.

The carrousel, which rotates about its own vertical axis, carries a plurality of pans also rotating about their own respective vertical axis parallel to that of the carrousel.

According to the prior art, the tangential velocity of the peripheral surface of the container is equal to the tangential velocity of the transfer roller.

The present invention relates more specifically to the transfer roller of the labels in which the holding of the labels themselves is obtained by means of aspiration creating a vacuum inside the roller and the transport of the containers takes place by means of a carrousel. A particularly acute problem in this type of machine is that of maintaining the label in contact with the container during the whole transfer from the roller to the container to prevent the label from flapping and positioning itself in an incorrect manner around the container.

The flapping phenomenon occurs particularly with films made of thin plastic material. This problem has already been solved for cylindrical containers by an aspirating roller of the type disclosed in European Patent EP 455 377 in which the surface of the roller is so shaped as to have, during the entire transfer phase of the label, between roller and container a space substantially equal to the thickness of the label. More specifically the lateral surface of the transfer roller is so shaped as to be always tangential to the container during its entire translation phase from the starting position of the labeling operation to the ending position thereof.

The label therefore remains confined in a very limited space and it is not allowed to effect any transverse flapping motions.

It has been observed that the solution disclosed in Patent EP 455 377 solves the aforesaid problem only and exclusively for perfectly cylindrical containers and for containers made of PET or PVC, i.e. flexible containers.

### SUMMARY OF THE INVENTION

The aim of the present invention is to eliminate the aforesaid drawbacks by making available a machine able to label containers of any shape and any material, such as containers with square cross section and containers made of glass having quite inaccurate dimensional measurements.

Said aims are fully achieved by the labeling machine for containers with non cylindrical section constituting the subject of the present invention, of the type in which the labels are obtained from a reeled film and in which the label transfer roller is of the aspirating type and the containers are transported by a plurality of rotating pans mounted on a carrousel, itself rotating, which is characterized by the contents of the claims set out below and in particular in that it comprises a transfer roller of the aspirating type in which the points of contact for the application of the glue and for positioning the label on the container are all along a circumference centered on the axis of rotation of the roller whilst the entire lateral surface of the roller is considerably recessed relative to said circumference and to the surface of the containers to allow labeling containers of various shapes.

A further characteristic is given by the fact that the rotational motion of the pan and hence of the container about its axis is greater than would be needed simply for wrapping the label inducing a dragging or sliding of the label itself on the container.

One thereby advantageously obtains for the label being transferred to be maintained under tension during the entire labeling phase, even though the container is at a considerable distance from the lateral surface of the transfer roller.

The transfer roller touches the container only in two points in proximity to the vertical edges of the label.

### BRIEF DESCRIPTION OF THE DRAWINGS

This and other features shall become more readily apparent from the following description of a preferred embodiment illustrated, purely by way of non limiting example, in the accompanying drawing tables, in which:

FIGS. 1 through 5 schematically show an aspirating roller for transferring the labels on the containers in the various operating sequences;

FIG. 6 schematically shows a detail of the aspirating transfer roller and a variation of the directions of rotation.

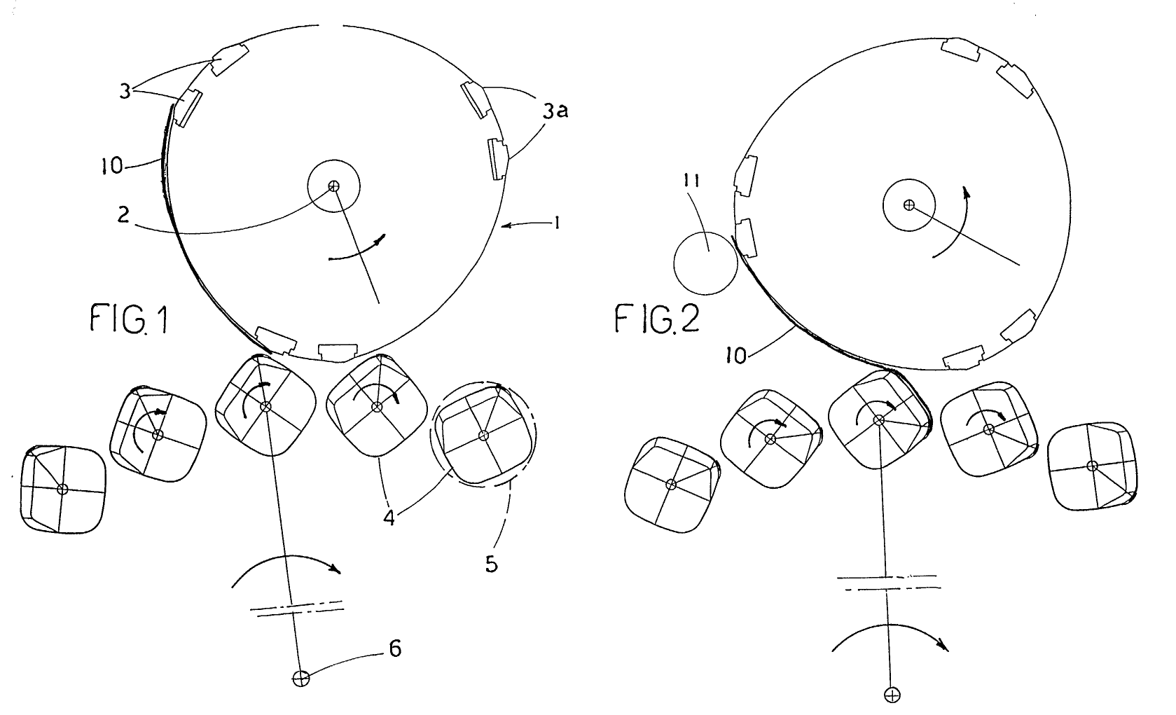

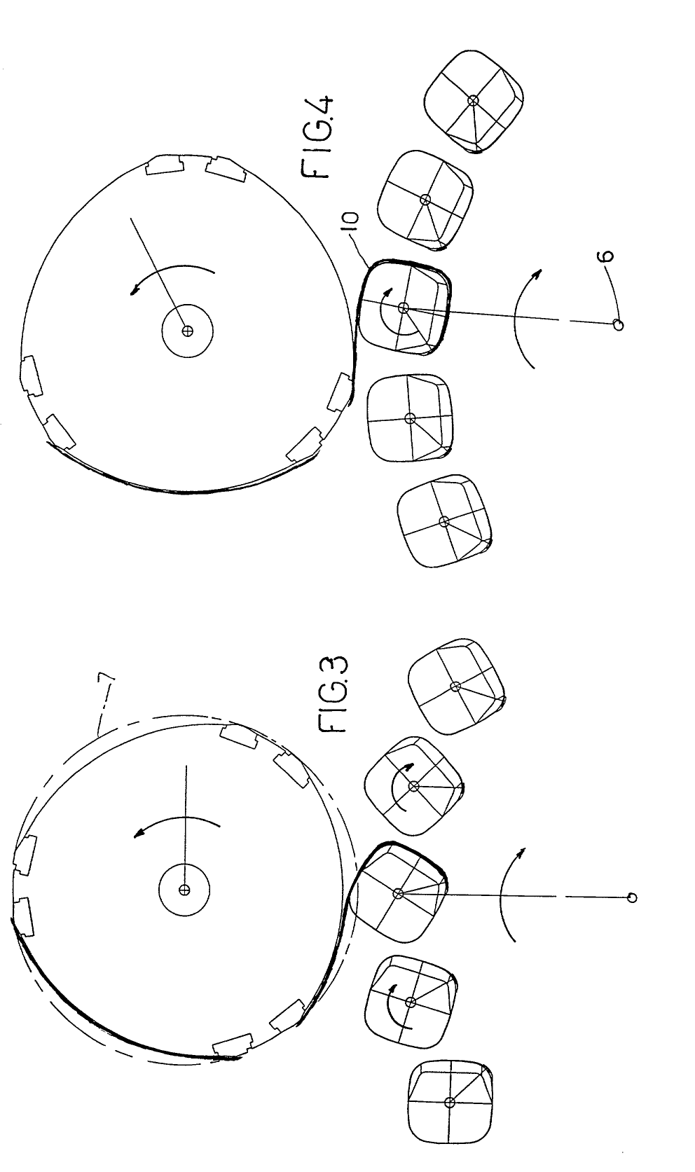

### DESCRIPTION OF THE PREFERRED EMBODIMENTS

With reference to the figures, the number 1 globally indicates a transfer roller rotating at a constant angular velocity, counter-clockwise, about its own vertical axis 2.

The roller is of the aspirating type according to known techniques, not shown herein, and it has pairs of pads 3 on its external surface; in the example shown, three pairs positioned 120° apart from each other, are present. Each pad 3 extends vertically along a generatrix of the roller and has a slight edge 3a. All edges 3a of the pads lie on a circumference 7 centered on the axis of rotation 2 of the roller 1 and define contact points with a glue roller and with a container.

The reference number 4 indicates containers having substantially square section which bear on pads 5 borne, in turn, by a known carrousel whereof only the axis of rotation 6 is shown herein.

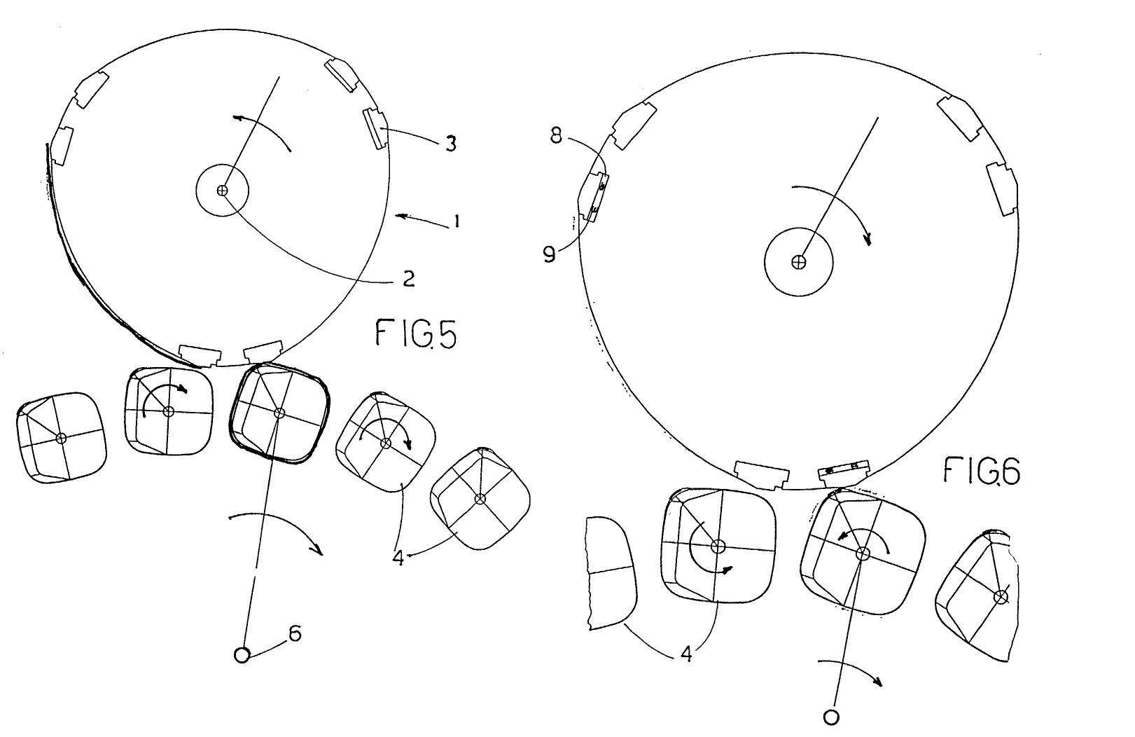

In the illustrated embodiment, carrousel and pads both rotate clockwise, whereas in the embodiment of FIG. 6 the pads and the transfer roller rotate counter-clockwise.

The velocity of rotation of the pads is predetermined, according to the dimension, the shape of the section of the containers and the length of the label to be labeled.

Said velocity of rotation must be such as to cause a sliding of the label 10 on the transfer roller, sliding by a few millimeters such as to allow the constant tensioning of the label during the transfer and hence to prevent it from flapping even when the container is at a considerable distance from the roller.

To label containers having non circular section it is necessary to maintain the containers at a certain distance from the roller and to have contact with the roller itself only along the generatrix in which the gluing of the label takes place.

It is therefore essential for the roller not to be cylindrical but to have, between the pairs of pads, recessed areas relative to the circumference 7.

Each pad 3 is inserted in a housing 8 obtained in the roller and it is kept pressed radially towards the exterior of the roller by elastic means 9.

The elastic means 9 may be strips of natural or synthetic rubber, springs made of steel, for instance Belleville washers or any other elements which may allow the pad to enter into the housing 8 in case of rigid containers with deformations outside the standard shape and unpredictable, as frequently occurs in glass containers.

The reference number 11 indicates a known glue dispenser roller, not described in detail, which is skimmed by the contact points 3a to distribute the glue along both vertical edges of the label, edges which may be superposed as shown in FIG. 5, or remain distanced. The distribution of the glue could also take place in points or strips instead of along the entire length of the vertical edges.

In the description and in the drawings, specific reference is made to a roller with three-lobe shape, but a two-lobe shape could also be employed, or the recessing area of the roller could also have different shapes: for instance, it could have notches recessing into the roller or it could have circular shape with unions in correspondence with the pairs of pads 3.

The shoe that holds the vertical side or rear edge of the label is made with natural or synthetic material which increases the local friction coefficient in correspondence with said rear edge.

The description and the drawings refer to the labeling of a container having substantially square section but it is evident that the machine can also function with containers having circular section or in any case with containers having axial-symmetric section, since the tensioning of the label is assured by the sliding of the label on the roller.

What is claimed:

1. A labeling machine for containers having non cylindrical section of the kind in which the labels are obtained from a reeled film and in which the roller for transferring the labels is of the aspirating kind and the containers are transported by a plurality of pans or plates rotating and mounted on a carrousel, itself rotating about a vertical axis, wherein the transfer roller (1) has points of contact (3a) for the application of the glue and for positioning the label on the container which are all positioned along a circumference (7) centered on the axis of rotation of the roller, whilst the whole lateral surface of the roller is considerably recessed relative to said circumference, the profile of the containers coming in contact with the roller only with a pair of said contact points.

2. A machine as claimed in claim 1, wherein the lateral surface of the transfer roller (1) has two-lobe or three-lobe shape.

3. A machine as claimed in claim 1, wherein the lateral surface of the transfer roller has notches recessing into the roller.

4. A labeling machine as claimed in claim 1, wherein the velocity of rotation of the pans (5) of the carrousel is such as to induce a dragging or sliding of the label (10) on the roller (1) during the transfer of the label itself on the container.

5. A labeling machine as claimed in claim 1, wherein the transfer roller has at least two pairs of pads (3) whereon are obtained the contact points (3a), said pads being inserted in housings (8) in which elastic means (9) are provided which allow radial displacements of the pads within the transfer roller.

6. A labeling machine as claimed in claim 1, wherein the transfer roller has at least two pairs of shoes (3) which provide the contact points (3a), the shoe that holds the rear edge of the label being made of natural or synthetic rubber material.

7. A machine as claimed in claim 1, wherein the transfer roller has a cylindrical lateral surface with unions in correspondence with the pairs of pads.
